(19) United States
(12) Patent Application Publication
(10) Pub. No.: US 2022/0090575 A1
(43) Pub. Date: Mar. 24, 2022

(54) WATER CURRENT TURBINE

(71) Applicant: HYMAGO ENERGIE, Versailles (FR)

(72) Inventor: Arnaud CHALRET DU RIEU, Maleville (FR)

(21) Appl. No.: 17/429,114

(22) PCT Filed: Jan. 28, 2020
(86) PCT No.: PCT/FR2020/050126

§ 371 Date: Aug. 6, 2021

(30) Foreign Application Priority Data
Feb. 8, 2019 (FR) 1901273

(51) Int. Cl. F03B 17/06

(52) U.S. Cl. CPC F03B 17/062

(57) ABSTRACT

Disclosed is a water turbine including an endless chain with buckets and two floats disposed on either side of the chain, the chain driving electricity generators.

### CROSS-REFERENCE TO RELATED APPLICATIONS

This application is the U.S. national phase of International Application No. PCT/FR2020/050126 filed Jan. 28, 2020 which designated the U.S. and claims priority to FR Patent Application No. 1901273 filed Feb. 8, 2019, the entire contents of each of which are hereby incorporated by reference.

### BACKGROUND OF THE INVENTION

### Field of the Invention

The present invention relates to the field of water turbines, in particular floating river turbines, but not exclusively.

### Description of the Related Art

Known water turbines generally comprise turbines the axis of which is horizontal and parallel to the flow of water that drives the water turbine. These water turbines have a deep draft and have low efficiency compared with their size. They must therefore be used in sufficiently deep water. Furthermore, the electricity generator is immersed, and disposed in the axis of the turbine, which makes it difficult to maintain it. In addition, the generator that can be driven by such a turbine is generally of low power, typically 40 kVA.

### SUMMARY OF THE INVENTION

The aim of the invention is to propose a water turbine that can be used in shallow water, and having improved efficiency compared with the known water turbines of the prior art.

To achieve its aim, the invention proposes a water turbine comprising:
an endless bucket chain and two axles disposed substantially in the same horizontal plane and parallel to each other, so that a movement of the chain causes a rotation of each of the axles; and
at least one electricity generator and means for transmitting the rotation movement of an axle to an input shaft of the generator.

Advantageously, the water turbine comprises means for vertically adapting the position of said water turbine to the level of the water on which it is installed, these means preferably comprising two floats disposed on either side of the chain.

It may also comprise a platform disposed above the chain. The platform may furthermore form a catamaran with the floats. The at least one generator is advantageously attached to the platform.

The water turbine preferably comprises four generators and four transmissions, each of the transmissions being disposed at a respective end of each of the axles, each transmission driving a respective generator. Each transmission may be a belt transmission.

### BRIEF DESCRIPTION OF THE DRAWINGS

Several embodiments of the invention will be described below, by way of non-limitative examples, with reference to the accompanying drawings, in which:

FIG. 1 is a schematic view in front three-quarter perspective of a water turbine according to the invention;

FIG. 2 is a schematic plan view of the water turbine of FIG. 1;

FIG. 3 is a schematic left-hand view of the water turbine of FIG. 1, in the direction III-III indicated in FIG. 2;

FIG. 4 is a schematic front view of the water turbine of FIG. 1, in the direction IV-IV indicated in FIG. 2;

FIG. 5 is a schematic plan view of a first anchoring method for the water turbine of FIG. 1;

FIG. 6 is a schematic front view of a second anchoring method for the water turbine of FIG. 1; and

FIG. 7 is a schematic plan view of a third anchoring method for the water turbine of FIG. 1.

### DESCRIPTION OF THE PREFERRED EMBODIMENTS

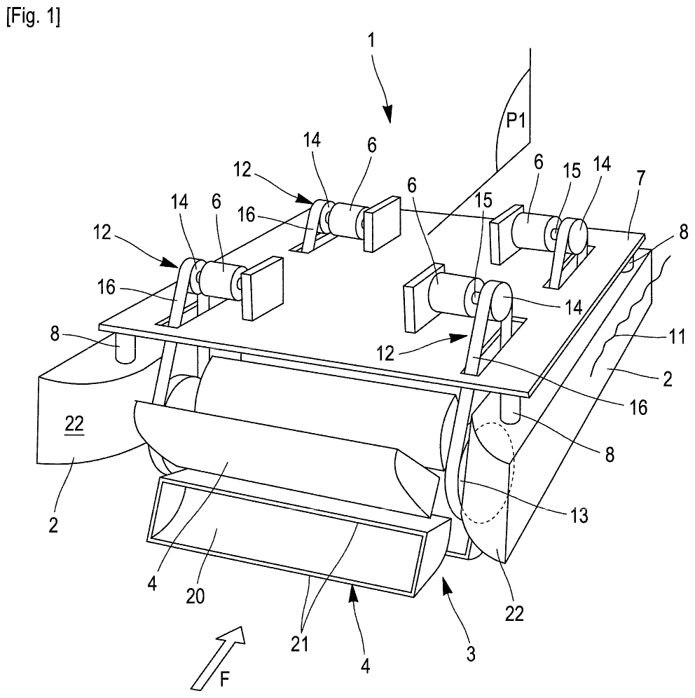

FIG. 1 illustrates a water turbine 1 according to the invention. This water turbine is substantially symmetrical in relation to a vertical longitudinal plane P1. It comprises two floats 2, an endless chain 3 with buckets 4 and electricity generators 6. It further comprises a horizontal platform 7.

The floats 2 are longitudinally elongate in form, parallel to each other, on either side of the chain 3. The platform 7 is attached to the floats 2, above the chain 3, by means of uprights 8. The uprights 8 extend upwards from the floats 2. The water turbine is thus in the form of a catamaran.

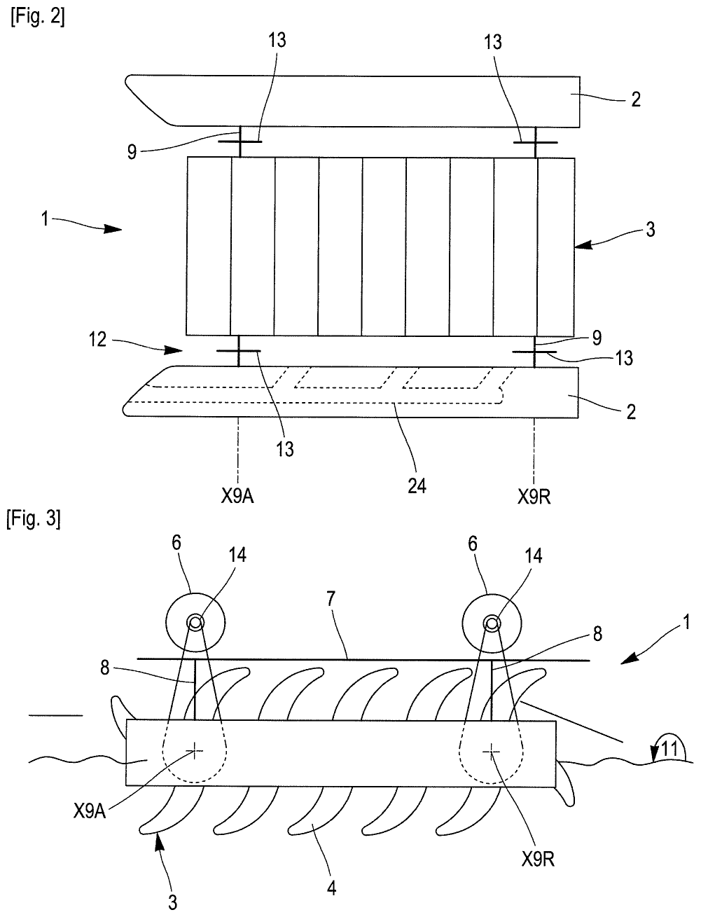

As particularly illustrated in FIGS. 2 to 4, the chain is mounted on two axles 9, parallel to each other and substantially in the same horizontal plane. A first axle is mounted around a front transverse axis X9A; the second axle is mounted around a rear transverse axis X9R.

The axles are carried by the floats, in the vicinity of the water line 11. The chain 3 is mounted on the axles so that the buckets can have the following closed travel:

moving horizontally from rear to front, above the water line;

tilting downwards about the front axis X9A;

moving horizontally from front to rear, below the water line; and

tilting upwards about the rear axis X9R.

Transmissions 12 are mounted between the axles 9 and the electricity generators 6. In the example illustrated the transmissions are belt transmissions. There are four transmissions, one at each end of each of the axles. Each transmission is designed to transmit the rotation movement of an axle to a respective generator 6.

Each transmission comprises a primary pulley 13, mounted so as to be secured in rotation with the corresponding axle, a secondary pulley 14, mounted so as to be secured in rotation with an input shaft 15 of the corresponding generator, and a belt 16, mounted in engagement with the two pulleys. The generators 6 are attached to the platform 7.

The buckets 4 are identical to each other. They have an oblong opening 20, elongate horizontally between two horizontal rectilinear edges 21. The buckets are concave and disposed so that they are open towards the front during movement from front to rear, below the water line. Preferably, each bucket is directly articulated with the two adjacent buckets, so that they are secured to each other. Thus two adjacent buckets are articulated about a horizontal transverse shaft, this shaft being carried by each of the two buckets.

Each float 2 has, at the front, a beveled part 22, so that the parts of the floats approach each other when traveling through them from front to rear.

The water turbine is designed to be disposed with the current, in a flow of water F, for example down a river or a canal or in a sea current. It is disposed so that the front thereof is directed towards the upstream of the flow and the rear towards the downstream of the flow. The beveled part 22 of the floats makes it possible to concentrate part of the flow F in the direction of the buckets.

In the example illustrated in FIG. 2, each float may comprise pipes 24 (shown in broken lines on the left float) to take off water from the flow F, upstream of the chain 3, and to release it further downstream, to boost buckets that are masked by buckets further upstream.

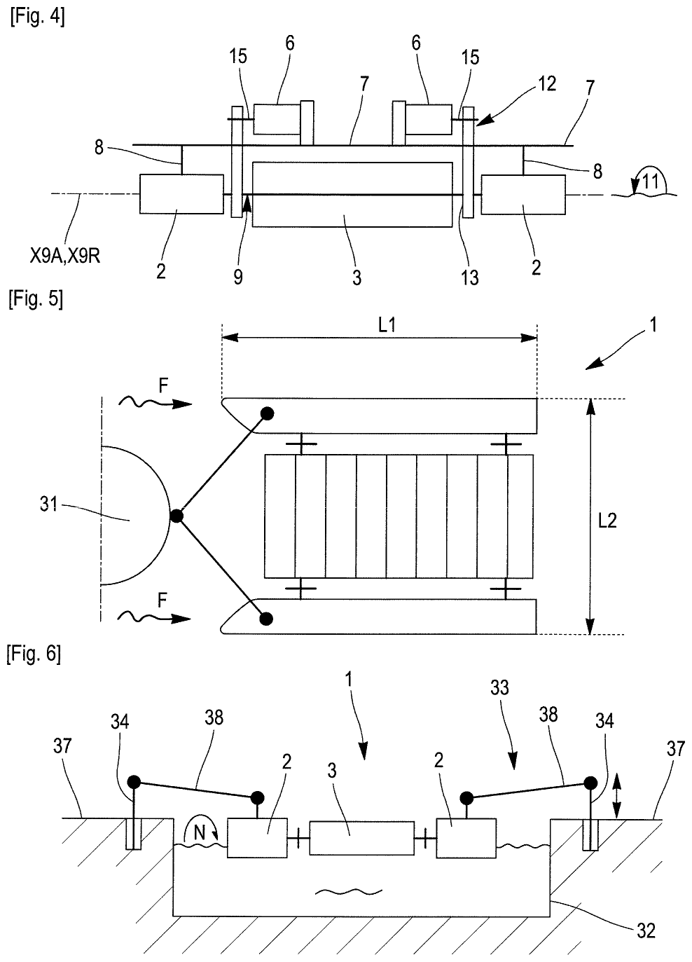

FIG. 5 illustrates a water turbine according to the invention moored to the pier 31 of a bridge.

FIG. 6 illustrates the water turbine mounted in a canal 32 the water level N of which can vary. In this embodiment, the anchoring is formed by a carrier structure 33.

This structure 33 comprises two vertical uprights 34 and linkages 38. Each linkage 38 connects a respective upright 34 with the float 2 closest to this upright. One end of the linkage is articulated with the upright; an opposite end is articulated with the float. Each upright 34 is mounted so as to slide vertically in a respective embankment 37.

Thus the sliding of the uprights sliding in the embankment makes it possible to absorb a variation in the level N of the water over a large amplitude and/or a long period, for example over a day or more. The articulated linkages make it possible to absorb more rapid variations, for example a swell. They also make it possible to react quickly to a passage of a person on the platform 7.

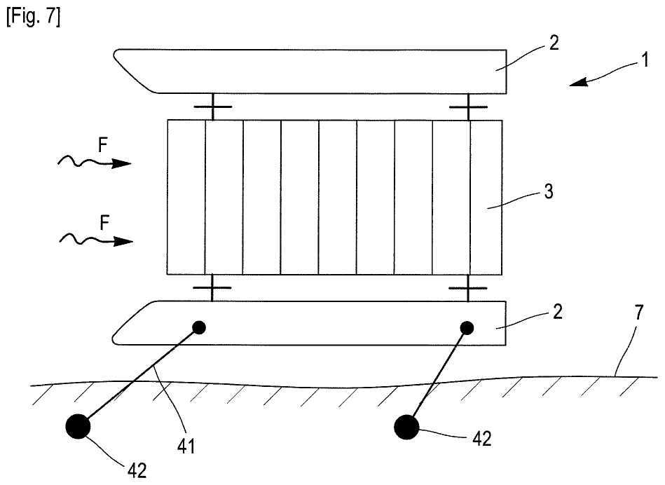

FIG. 7 illustrates the anchoring of the water turbine 1 along an embankment 7. It is held thereon by cables 41 attached to bollards 42.

In the example illustrated, the length L1 of the water turbine is approximately 6 to 8 meters, the width thereof is approximately 3 to 5 meters, and the draft approximately 50 centimeters. Each generator is a 150 kVA generator, so that in the example illustrated the water turbine has a production capacity of 600 kVA.

Naturally the invention is not limited to the preferred embodiments that have just been described but, on the contrary, the invention is defined by the following claims.

It will be clear in fact to a person skilled in the art that various modifications can be made to the embodiments described above, in the light of the teaching that has just been disclosed.

Thus a water turbine can be attached to a mooring buoy, in particular in a tidal zone, so that it can change orientation according to the direction of the flow to which it is subjected.

Also, there may be a different number of generators. For example, it is possible to have a single high-power generator. It is also possible to have eight of them, two per transmission, with lower power, which are less expensive, and can more easily be replaced without lastingly affecting the production of electricity.

In particular in the case of a canal with a substantially constant flow rate and level, a water turbine according to the invention may not comprise floats and bear directly on only one or on both embankments of the canal.

The floats, like the linkages and the uprights, constitute means for vertically adapting the position of the water turbine to the level of the watercourse on which it is installed.

A water turbine according to the invention is particularly advantageous. This is because:

it does not require any civil engineering, and therefore has a low environmental and social impact;

the commissioning and decommissioning costs and times are small;

the draft is small;

maintenance is simplified, since no electrical part (cable, generator, etc.) is immersed or in direct contact with the water;

the axles make it possible to drive a plurality of generators, optimally four generators, as previously described;

the proximity to the banks allows easier service of an urban network;

it can easily be installed in an area remote from a network, for example for a building site, a country fete or in a remote area with no electrical installation.

Such a water turbine makes it possible to exploit the electrical potential of watercourses that are little or not exploited.

Furthermore, the use of a bucket chain mounted on two horizontal axes makes it possible to drive four electricity generators with higher power (typically 150 kVA) than current technology that uses a single immersed generator of low capacity (typically 40 kVA).

1. A water turbine comprising:
an endless chain with buckets and two axlesdisposed substantially in the same horizontal plane and parallel to each other, so that a movement of the chain causes a rotation of each of said axles,
at least one electricity generatorand means for transmitting the rotation movement of an axle to an input shaft of said generator.

2. The water turbine according to claim 1, further comprising means for vertically adapting the position of said water turbine to the level of the water on which the water turbine is installed.

3. The water turbine according to claim 1, further comprising a platform disposed above the chain.

4. The water turbine according to claim 1, wherein said means for vertically adapting the position of said water turbine comprises two floats disposed on either side of the chain, and wherein the platform (7) forms a catamaran with the floats.

5. The water turbine according to claim 3, wherein the at least one generator is attached to the platform.

6. The water turbine according to claim 1, further comprising four generators and four transmissions, each of the transmissions being disposed at a respective end of each of the axles, each transmission driving a respective generator.

7. The water turbine according to claim 1, wherein each transmission is a belt transmission.

8. The water turbine of claim 2, wherein the means for vertically adapting the position of said water turbine comprises two floats disposed on either side of the chain.

9. The water turbine according to claim 2, further comprising a platform disposed above the chain.

10. The water turbine according to claim 4, wherein the at least one generator is attached to the platform.

11. The water turbine according to claim 9, wherein the at least one generator is attached to the platform.

12. The water turbine according to claim 2, further comprising four generators and four transmissions, each of the transmissions being disposed at a respective end of each of the axles, each transmission driving a respective generator.

13. The water turbine according to claim 3, further comprising four generators and four transmissions, each of the transmissions being disposed at a respective end of each of the axles, each transmission driving a respective generator.

14. The water turbine according to claim 4, further comprising four generators and four transmissions, each of the transmissions being disposed at a respective end of each of the axles, each transmission driving a respective generator.

15. The water turbine according to claim 5, further comprising four generators and four transmissions, each of the transmissions being disposed at a respective end of each of the axles, each transmission driving a respective generator.

16. The water turbine according to claim 2, wherein each transmission is a belt transmission.

17. The water turbine according to claim 3, wherein each transmission is a belt transmission.

18. The water turbine according to claim 4, wherein each transmission is a belt transmission.

19. The water turbine according to claim 5, wherein each transmission is a belt transmission.

20. The water turbine according to claim 6, wherein each transmission is a belt transmission.
